(19) United States
(12) Patent Application Publication
(10) Pub. No.: US 2026/0339663 A1
(43) Pub. Date: Oct. 29, 2026

(54) METHOD FOR IMPLEMENTING TASK, ELECTRONIC DEVICE, AND STORAGE MEDIUM

(71) Applicant: Lenovo (Beijing) Limited, Beijing (CN)

(72) Inventors: Zhangnan XIANG, Beijing (CN); Jiahao ZHOU, Beijing (CN)

(21) Appl. No.: 19/656,331

(22) Filed: Apr. 23, 2026

(30) Foreign Application Priority Data
Apr. 29, 2025 (CN) 202510560915.6

(51) Int. Cl. G06F 9/30

(52) U.S. Cl. CPC G06F 9/30003

(57) ABSTRACT

The present disclosure discloses a method for implementing a task. The method includes: receiving target request information that describes a first task to be implemented; determining, based on the target request information, target reference information from a target knowledge base, where the target reference information describes execution steps of a second task, and the second task and the first task satisfy a similarity relationship; determining target input information based on the target request information and the target reference information; and, inputting the target input information into a target model to obtain a target control instruction generated by the target model, where the target control instruction controls a target device to execute the first task.

The present disclosure claims priority to Chinese Patent Application No. 202510560915.6, filed on Apr. 29, 2025, the content of which is incorporated herein by reference in its entirety.

### TECHNICAL FIELD

The present disclosure relates to the field of artificial intelligence, and more specifically, relates to a method and an apparatus for implementing a task.

### BACKGROUND

In existing technology, a program is able to output control instructions to control a device to perform interaction operations on an operation interface of the device, thereby completing a specified task. However, the accuracy of the output control instructions is low, resulting in poor task completion performance.

### SUMMARY

One aspect of the present disclosure provides a method for implementing a task. The method includes: receiving target request information that describes a first task to be implemented; determining, based on the target request information, target reference information from a target knowledge base, where the target reference information describes execution steps of a second task, and the second task and the first task satisfy a similarity relationship; determining target input information based on the target request information and the target reference information; and, inputting the target input information into a target model to obtain a target control instruction generated by the target model, where the target control instruction controls a target device to execute the first task.

Another aspect of the present disclosure provides an electronic device. The electronic device includes: one or more processors and a memory. The memory stores instructions that, when being executed, cause the one or more processors to: receive target request information that describes a first task to be implemented; determine target reference information from a target knowledge base based on the target request information, where the target reference information describes execution steps of a second task, and the second task and the first task satisfy a similarity relationship; determine target input information based on the target request information and the target reference information; and, input the target input information into a target model to obtain a target control instruction generated by the target model, where the target control instruction controls a target device to execute the first task.

Yet another aspect of the present disclosure provides a non-transitory computer-readable storage medium storing instructions that, when being executed, cause at least one processor to: receive target request information that describes a first task to be implemented; determine target reference information from a target knowledge base based on the target request information, where the target reference information describes execution steps of a second task, and the second task and the first task satisfy a similarity relationship; determine target input information based on the target request information and the target reference information; and, input the target input information into a target model to obtain a target control instruction generated by the target model, where the target control instruction controls a target device to execute the first task.

### BRIEF DESCRIPTION OF THE DRAWINGS

The accompanying drawings are incorporated into and form a part of the present specification, and illustrate embodiments consistent with the present disclosure. Together with the specification, the drawings serve to explain the technical solutions of the present disclosure. It will be apparent that the drawings described below merely illustrate some embodiments of the present disclosure. Those of ordinary skill in the art may obtain other drawings based on these drawings without undue experimentation.

The flowcharts illustrated in the drawings are provided for exemplary description only, and are not required to include all contents and operations/steps, nor are they required to be performed in the order described. For example, some operations/steps may be further divided, and some operations/steps may be combined or partially combined. Accordingly, an actual execution sequence may be changed based on practical conditions.

FIG. 1 illustrates a first schematic flowchart of a method for implementing a task in accordance with some embodiments of the present disclosure.

FIG. 2 illustrates a second schematic flowchart of a method for implementing a task in accordance with some embodiments of the present disclosure.

FIG. 3 illustrates a schematic flowchart of determining candidate reference information in accordance with some embodiments of the present disclosure.

FIG. 4 illustrates a third schematic flowchart of a method for implementing a task in accordance with some embodiments of the present disclosure.

FIG. 5 illustrates a fourth schematic flowchart of a method for implementing a task in accordance with some embodiments of the present disclosure.

FIG. 6 illustrates a schematic structural diagram of an apparatus for implementing a task in accordance with some embodiments of the present disclosure.

FIG. 7 illustrates a schematic structural diagram of an electronic device in accordance with some embodiments of the present disclosure.

### DETAILED DESCRIPTION

In order to make the objectives, technical solutions, and advantages of the present disclosure clearer, the technical solutions of the present disclosure are further described in detail below with reference to the accompanying drawings and embodiments. The described embodiments shall not be construed as limiting the present disclosure. All other embodiments obtained by those of ordinary skill in the art without undue experimentation shall fall within the scope of protection of the present disclosure.

In the following description, references to “some embodiments” describe a subset of all possible embodiments. It should be understood that “some embodiments” may include the same subset or different subsets of all possible embodiments, and may be combined with each other without conflict.

Those of ordinary skill in the art will understand that, unless otherwise defined, all terms (including technical terms and scientific terms) used herein have the same meaning as commonly understood by those of ordinary skill in the art to which the embodiments of the present disclosure belong. It should also be understood that terms defined in commonly used dictionaries should be interpreted as having meanings consistent with their meanings in the context of the relevant technology, and shall not be interpreted in an idealized or overly formal sense unless expressly defined herein.

Terms such as “first,” “second,” and “third” used in the embodiments of the present disclosure are for illustrative and distinguishing purposes only, and do not imply any order, nor do they indicate any particular limitation on the number of devices, and thus shall not be construed as limiting the present disclosure.

To facilitate understanding of the technical solutions of the embodiments of the present disclosure, relevant technologies are described below. The following relevant technologies may be arbitrarily combined with the technical solutions of the embodiments of the present disclosure and shall fall within the scope of protection of the present disclosure.

A Large Action Model (LAM) framework includes three components: a core multi-modality large language model (Multi-modality Large Language Model, MM-LLM), a perception module configured to perceive external information, and a control module configured to control external operations. When completing a user task, the LAM executes steps in sequence. Specifically, the perception module first collects information of a current interface; subsequently, the MM-LLM determines an action for a current step based on the collected information and an execution history of a previous step; the action of the current step is executed by the control module; and execution of the action causes the interface to change. Such a cycle is repeated until the user task is completed.

During this process, whether the user task is successfully executed mainly depends on the capability of the MM-LLM and the perception accuracy of the perception module. Due to characteristics of the LLM, results generated in each execution process are not completely identical, thereby affecting execution of the same task, and a task that has been successfully executed previously is not guaranteed to always succeed. In addition, operation processes of some applications include a plurality of personalized operations that are strongly related to user information and operation habits. For example, when booking airline tickets, a user may prefer a specific airline, and when booking hotels, a user may prefer certain hotel brands. Therefore, the user task may not necessarily be executed according to user expectations.

In existing technology, a user is allowed to manually create an execution flow, including clicking controls, inputting text, and the like. However, once the execution flow is created, it becomes fixed, and therefore is only able to solve a fixed task. That is, such a technical solution is not able to adapt to task variations and is also not able to adapt to changes in an operation interface. If an interface of an operation object changes or is updated, a solution relying solely on text matching is likely to fail, because text manually created by the user is likely to be updated.

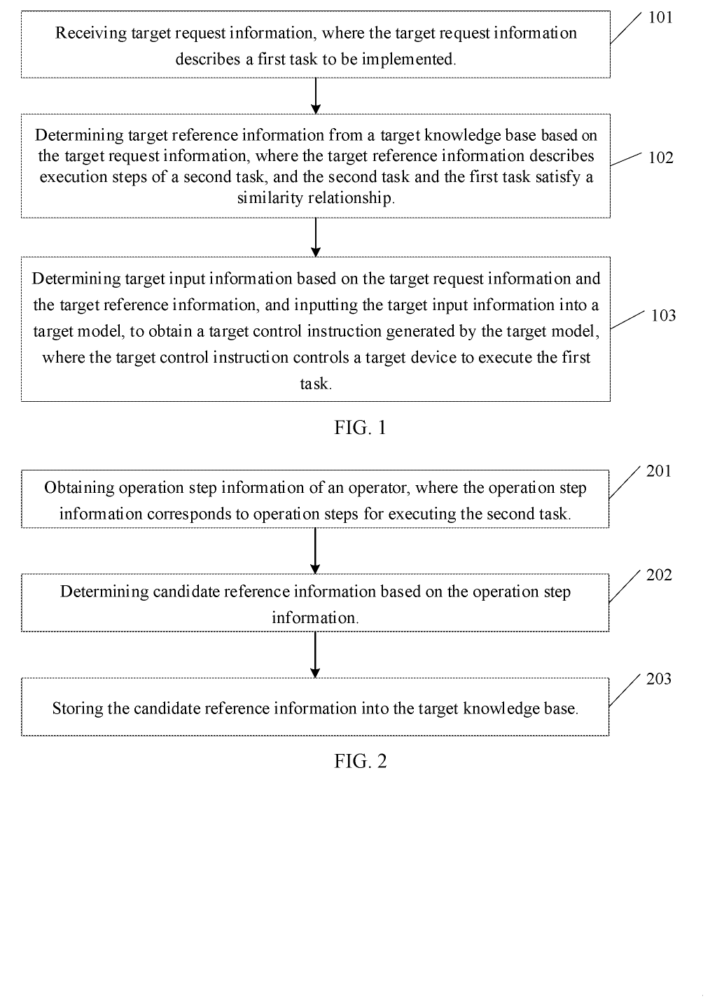

In view of the above, embodiments of the present disclosure provide a method for implementing a task. FIG. 1 illustrates a first schematic flowchart of a method for implementing a task in accordance with some embodiments of the present disclosure. As shown in FIG. 1, the method includes steps 101 to 103.

Step 101: receiving target request information, where the target request information describes a first task to be implemented.

Step 102: determining target reference information from a target knowledge base based on the target request information, where the target reference information describes execution steps of a second task, and the second task and the first task satisfy a similarity relationship.

Step 103: determining target input information based on the target request information and the target reference information, and inputting the target input information into a target model, to obtain a target control instruction generated by the target model, where the target control instruction controls a target device to execute the first task.

It should be understood that, according to some embodiments of the present disclosure, when target request information is received, target reference information is determined from a target knowledge base configured to describe execution steps of at least one second task. Based on the target request information and the target reference information, target input information is determined and input into a target model to obtain a target control instruction generated by the target model, thereby controlling a target device to execute a first task, where the first task and the second task satisfy a similarity relationship. In this manner, based on target reference information of the second task similar to the first task, the target input information is determined, and further the target control instruction is generated, such that the generated target control instruction is more accurate and more consistent with operator preferences.

Various implementations of the above steps and related terms are described below.

In step 101, target request information is received, where the target request information describes a first task to be implemented.

It should be understood that, according to some embodiments of the present disclosure, the target request information is not limited, provided that the target request information is able to describe the first task to be implemented.

In some embodiments of the present disclosure, the target request information includes information input by a user, or information obtained based on user operations.

In some embodiments of the present disclosure, the target request information includes a parameter set of the first task, where the parameter set includes at least one of: a format of input data, an expected output indicator, or an environmental constraint condition.

In some embodiments of the present disclosure, the target request information further includes a task identifier of the first task, where the task identifier is configured to uniquely identify a technical objective and an execution condition of the first task.

In some embodiments of the present disclosure, the target request information includes a task type, input data, a performance index, and a hyperparameter constraint, and the like.

In step 102, target reference information is determined from a target knowledge base based on the target request information. Where, the target reference information describes execution steps of a second task, and the second task and the first task satisfy a similarity relationship.

It should be understood that, according to some embodiments of the present disclosure, the target knowledge base is not limited. In some embodiments of the present disclosure, the target knowledge base is a preset target knowledge base. In other embodiments of the present disclosure, the target knowledge base is obtained by processing operation step information of at least one second task executed by an operator. In yet other embodiments of the present disclosure, the target knowledge base is obtained by updating the preset target knowledge base based on the operation step information of at least one second task executed by the operator.

In some embodiments of the present disclosure, FIG. 2 illustrates a second schematic flowchart of a method for implementing a task in accordance with some embodiments of the present disclosure. As shown in FIG. 2, the method further includes steps 201 to 203.

Step 201: obtaining operation step information of an operator, where the operation step information corresponds to operation steps for executing the second task.

Step 202: determining candidate reference information based on the operation step information.

Step 203: storing the candidate reference information into the target knowledge base.

It should be understood that, according to some embodiments of the present disclosure, since the candidate reference information in the target knowledge base is obtained based on the operation step information of the operator, when executing a task to be executed, the generated target control instruction is more consistent with operator preferences, thereby facilitating execution of the task to be executed in a manner consistent with personalization of the operator.

It should be understood that, according to some embodiments of the present disclosure, the operation step information is not limited. In some embodiments of the present disclosure, the operation step information includes at least one step for executing the second task. In other embodiments of the present disclosure, the operation step information further includes an execution sequence of steps for executing the second task.

According to some embodiments of the present disclosure, a specific implementation of “obtaining operation step information of an operator” is not limited. In some embodiments of the present disclosure, obtaining operation step information of an operator includes: obtaining at least one step for implementing the second task; and determining the operation step information based on the at least one step of the second task.

According to some embodiments of the present disclosure, a specific implementation of “determining candidate reference information based on the operation step information” is not limited. In some embodiments of the present disclosure, determining candidate reference information based on the operation step information includes: obtaining operation description information input by the operator corresponding to the operation step information; and determining the candidate reference information based on the operation step information and the operation description information.

It should be understood that, according to some embodiments of the present disclosure, the operation description information corresponding to the operation step information is not limited. In some embodiments of the present disclosure, the operation description information describes execution intent information of steps in the operation step information.

According to some embodiments of the present disclosure, a specific implementation of “determining the candidate reference information based on the operation step information and the operation description information” is not limited. In some embodiments of the present disclosure, determining the candidate reference information based on the operation step information and the operation description information includes: determining execution intent information in the operation description information corresponding to steps in the operation step information to obtain the candidate reference information.

In some embodiments of the present disclosure, the candidate reference information includes at least one of: execution intent information corresponding to at least one step in the execution steps of the second task; or a control instruction corresponding to at least one step in the execution steps of the second task.

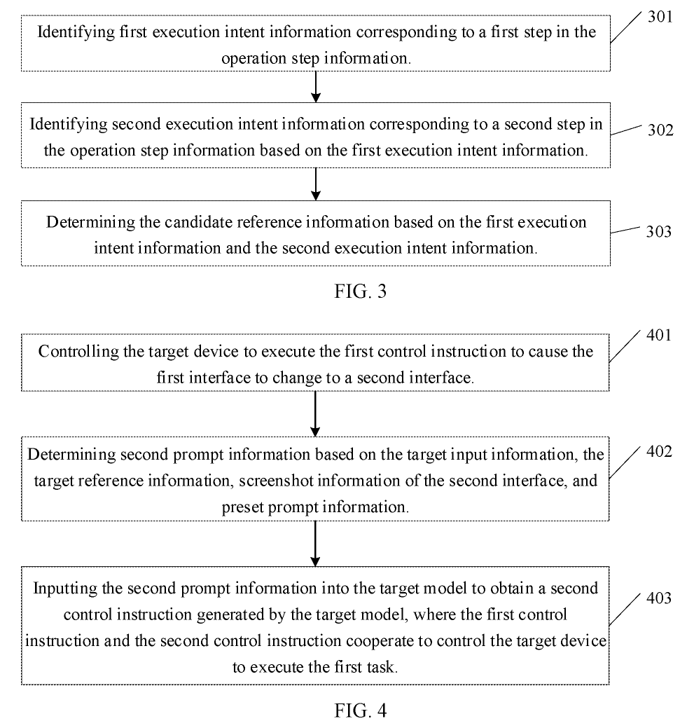

In other embodiments of the present disclosure, FIG. 3 illustrates a schematic flowchart of determining candidate reference information in accordance with some embodiments of the present disclosure. As shown in FIG. 3, candidate reference information may be determined based on the operation step information through steps 301 to 303.

Step 301: identifying first execution intent information corresponding to a first step in the operation step information.

Step 302: identifying second execution intent information corresponding to a second step in the operation step information based on the first execution intent information.

Step 303: determining the candidate reference information based on the first execution intent information and the second execution intent information.

In some embodiments of the present disclosure, an execution sequence of the first step precedes an execution sequence of the second step, and the first step and the second step are executed consecutively.

It should be understood that, according to some embodiments of the present disclosure, a specific implementation of “identifying first execution intent information corresponding to a first step in the operation step information” is not limited. In some embodiments of the present disclosure, identifying first execution intent information corresponding to a first step in the operation step information includes: if the first step is a first executed step in the second task, obtaining request information of the second task, where the request information describes the second task; and, determining a first execution intent corresponding to the first step based on the request information of the second task and the first step.

In some embodiments of the present disclosure, identifying second execution intent information corresponding to a second step in the operation step information based on the first execution intent information includes: determining a second execution intent corresponding to the second step based on the request information of the second task, the first execution intent, and the second step.

In some embodiments of the present disclosure, the candidate reference information includes at least one of: execution intent information corresponding to at least one step in the execution steps of the second task; or a control instruction corresponding to at least one step in the execution steps of the second task.

In some embodiments of the present disclosure, the target reference information includes at least one of: execution intent information corresponding to at least one step in the execution steps of the second task; or a control instruction corresponding to at least one step in the execution steps of the second task.

In some embodiments of the present disclosure, if the target reference information includes: execution intent information corresponding to at least one step in the execution steps of the second task, and a control instruction corresponding to at least one step in the execution steps of the second task, a step corresponding to the execution intent information is the same as a step corresponding to the control instruction.

In some embodiments of the present disclosure, the target reference information includes at least one of: execution intent information corresponding to at least one step in the execution steps of the second task; or at least one step in the execution steps of the second task.

In some embodiments of the present disclosure, the target reference information includes: execution intent information corresponding to at least one step in the execution steps of the second task, and at least one step in the execution steps of the second task, where the execution intent information corresponds to the step.

In some embodiments of the present disclosure, determining the target reference information from the target knowledge base based on the target request information includes: matching a target root node from the target knowledge base based on the target request information; and determining the target reference information from at least one piece of candidate reference information associated with the target root node, where each piece of candidate reference information corresponds to a candidate reference task.

It should be understood that, according to some embodiments of the present disclosure, a structure of the target knowledge base is not limited. In some embodiments of the present disclosure, a root node of the target knowledge base is a task framework, second-level child nodes of the target knowledge base are at least one second task (i.e., candidate reference tasks), and third-level child nodes of the target knowledge base are at least one piece of candidate reference information corresponding to the second task.

In some embodiments of the present disclosure, second tasks corresponding to second-level child nodes under the task framework are tasks of a same type.

In some embodiments of the present disclosure, the method further includes: determining execution intent information respectively corresponding to operation steps of the second task; deleting key information from the execution intent information respectively corresponding to the operation steps of the second task to determine a fuzzy execution intent; and generating a task framework of the second task based on the fuzzy execution intent.

In some embodiments of the present disclosure, the method further includes: if the target knowledge base includes the task framework of the second task, arranging the task framework of the second task in the target knowledge base as a root node of the second task; or, if the target knowledge base does not include the task framework of the second task, arranging the task framework of the second task as a root node in the target knowledge base, and arranging the second task as a second-level child node of the task framework of the second task.

According to some embodiments of the present disclosure, a specific implementation of “matching a target root node from the target knowledge base based on the target request information” is not limited. In some embodiments of the present disclosure, matching the target root node from the target knowledge base based on the target request information includes: determining, from root nodes in the target knowledge base, a target root node having a similarity with the target request information that satisfies a first similarity condition.

According to some embodiments of the present disclosure, a specific implementation of “determining the target reference information from at least one piece of candidate reference information associated with the target root node” is not limited. In some embodiments of the present disclosure, determining the target reference information from at least one piece of candidate reference information associated with the target root node includes: determining, from second-level child nodes of the target root node, a second task having a similarity with the target request information that satisfies a second similarity condition; and determining the target reference information from candidate reference information of the second task based on the target request information.

In some embodiments of the present disclosure, “determining the target reference information from candidate reference information of the second task based on the target request information” includes: generating an empty instruction and/or empty intent information corresponding to the empty instruction based on the target request information; determining, from execution intent information corresponding to at least one step in execution steps of the second task, reference execution intent information having a similarity with the empty intent information that satisfies a third similarity condition; determining execution intent corresponding to a next execution sequence step corresponding to the reference execution intent information as target reference intent information; and/or determining, from control instructions corresponding to at least one step in the execution steps of the second task, a reference control instruction having a similarity with the empty instruction that satisfies a fourth similarity condition; and determining a control instruction corresponding to a next execution sequence step of the reference control instruction as a target control instruction.

It should be understood that, according to some embodiments of the present disclosure, the empty intent information and the empty instruction are not limited. In some embodiments of the present disclosure, the empty intent information may be intent information having content of NULL, an empty string, all-zero data, or an undefined default value; and the empty instruction may be an instruction having content of NULL, an empty string, all-zero data, or an undefined default value.

In some embodiments of the present disclosure, if the target reference information includes: execution intent information corresponding to at least one step in the execution steps of the second task, and a control instruction corresponding to at least one step in the execution steps of the second task, then determining the target reference information from candidate reference information of the second task based on the target request information includes: generating an empty instruction and/or empty intent information corresponding to the empty instruction based on the target request information; determining, from the execution intent information corresponding to at least one step in the execution steps of the second task, a target step where the execution intent information satisfies a third similarity condition with the empty intent information, and a control instruction corresponding to the target step satisfies a fourth similarity condition with the empty instruction; determining reference execution intent information corresponding to a next execution sequence step of the target step as target reference intent information; and determining a control instruction corresponding to a next execution sequence step of the target step as a target control instruction.

In some embodiments of the present disclosure, generating an empty instruction and/or empty intent information corresponding to the empty instruction based on the target request information includes: when the target reference information is determined for a first time, generating the empty instruction and/or the empty intent information corresponding to the empty instruction based on the target request information.

In some embodiments of the present disclosure, when the target reference information is not determined for a first time, the empty instruction is replaced with a previously executed control instruction, and the empty intent information is replaced with execution intent information corresponding to the previously executed control instruction.

It should be understood that, according to some embodiments of the present disclosure, the first similarity condition, the second similarity condition, the third similarity condition, and the fourth similarity condition are not limited. The first similarity condition, the second similarity condition, the third similarity condition, and the fourth similarity condition may be the same or may be different. In some embodiments of the present disclosure, the first similarity condition, the second similarity condition, the third similarity condition, and the fourth similarity condition correspond to a highest similarity.

In step 103, target input information is determined based on the target request information and the target reference information, and the target input information is input into a target model to obtain a target control instruction generated by the target model, where the target control instruction is configured to control a target device to execute the first task.

In some embodiments of the present disclosure, determining the target input information based on the target request information and the target reference information includes: replacing first object information in the target reference information with second object information to obtain replacement reference information, where the second object information is determined from the target reference information; and determining the target input information based on the target request information and the replacement reference information.

In some embodiments of the present disclosure, the first object information and the second object information are information of a same attribute. Specifically, if the first object information is execution intent information corresponding to at least one step in execution steps of the second task, the second object information is execution intent information corresponding to at least one step in the execution steps of the second task; and/or if the first object information is a control instruction corresponding to at least one step in the execution steps of the second task, the second object information is a control instruction corresponding to at least one step in the execution steps of the second task.

In some embodiments of the present disclosure, the first object information is information determined based on a control instruction of an (i-2)-th execution, where the first object information is configured to determine information of a control instruction of an (i-1)-th execution; and the second object information is information determined based on a control instruction of an (i-1)-th execution, where the second object information is configured to determine information of a control instruction of an i-th execution. And/or, the first object information is execution intent information corresponding to a control instruction of the (i-2)-th execution, where the first object information is configured to determine information of a control instruction of the (i-1)-th execution; and the second object information is information determined based on execution intent information corresponding to a control instruction of the (i-1)-th execution, where the second object information is configured to determine information of a control instruction of the i-th execution. Where, i is greater than or equal to 2 and less than or equal to a number of target control instructions.

In some embodiments of the present disclosure, the method further includes: if the first task is successfully implemented, storing the first task, control instructions of the first task, and execution intent information corresponding to the control instructions of the first task in the target knowledge base to update the target knowledge base.

In some embodiments of the present disclosure, storing the first task, control instructions of the first task, and execution intent information corresponding to the control instructions of the first task in the target knowledge base includes: determining a task framework corresponding to the first task; if the target knowledge base includes the task framework corresponding to the first task, arranging the task framework of the first task in the target knowledge base as a root node of the first task; or, if the target knowledge base does not include the task framework corresponding to the first task, arranging the task framework of the first task as a root node in the target knowledge base, and arranging the first task as a second-level child node of the task framework of the first task; and, storing the control instructions of the first task and execution intent information corresponding to the control instructions of the first task in association, where the control instructions of the first task and the execution intent information corresponding to the control instructions of the first task are arranged as child nodes of the first task.

In some embodiments of the present disclosure, determining target input information based on the target request information and the target reference information and inputting the target input information into a target model includes: determining the target input information based on the target request information, the target reference information, screenshot information of a target interface, and preset prompt information, where the target input information guides the target model to perform inference, and where the target interface is configured for executing the target control instruction; and, inputting the target input information into the target model.

It should be understood that, according to some embodiments of the present disclosure, the preset prompt information is not limited. In some embodiments of the present disclosure, the preset prompt information is used to prompt generation of the target input information.

In some embodiments of the present disclosure, determining the target input information based on the target request information, the target reference information, the screenshot information of the target interface, and the preset prompt information includes: determining a reference instruction of the first task based on the target request information and the target reference information; and using the reference instruction of the first task, the target request information, the screenshot information of the target interface, and the preset prompt information as the target input information.

In other embodiments of the present disclosure, determining the target input information based on the target request information, the target reference information, the screenshot information of the target interface, and the preset prompt information includes: determining a reference instruction of the first task based on the target request information and the target reference information; determining execution intent information of a target control instruction based on the reference instruction of the first task, the target request information, the screenshot information of the target interface, and the preset prompt information; and inputting the execution intent information into the target model.

In some embodiments of the present disclosure, FIG. 4 illustrates a third schematic flowchart of a method for implementing a task in accordance with some embodiments of the present disclosure. As shown in FIG. 4, the target control instruction is a first control instruction, the target interface is a first interface, and the target input information is first input information. The method further includes steps 401 to 403.

Step 401: controlling the target device to execute the first control instruction to cause the first interface to change to a second interface.

Step 402: determining second prompt information based on the target input information, the target reference information, screenshot information of the second interface, and preset prompt information.

Step 403: inputting the second prompt information into the target model to obtain a second control instruction generated by the target model, where the first control instruction and the second control instruction cooperate to control the target device to execute the first task.

It should be understood that, according to some embodiments of the present disclosure, the target model is not limited. In some embodiments of the present disclosure, the target model is a pre-trained large language model.

According to some embodiments of the present disclosure, the second prompt information is used to prompt generation of the second control instruction. In some embodiments of the present disclosure, the second prompt information is execution intent information of the second control instruction. In some embodiments of the present disclosure, the target reference information in step 402 is determined based on the first control instruction and/or execution intent information corresponding to the first control instruction.

An exemplary application of the method for implementing a task provided by the present disclosure in a practical scenario is described below.

According to some embodiments of the present disclosure, a method for implementing a task is provided, where a learning module and a knowledge base module are introduced into a LAM framework. The learning module is not only used to create an execution flow to form a static operation script (i.e., one example of operation step information), but also to align user intent (i.e., one example of execution intent information of an operation), that is, a reason for performing a corresponding operation. Such additional information is stored in a knowledge base (i.e., one example of a target knowledge base) module, thereby continuously providing successful operation execution records during execution of tasks by the LAM. In subsequent execution of identical or similar tasks, the LAM is able to utilize previously successful cases and make decisions that are more consistent with user habits.

First, in response to user input, a script recorder based on User Interface Automation (UI Automation) (i.e., a Step Recorder) is used to record detailed user operations. Specifically, the script recorder records, but is not limited to, mouse clicks, scroll wheel operations, keyboard inputs, and the like.

Then, an obtained action sequence script (i.e., an Action Sequence Script) is provided to an Action Learner. Based on the action sequence of the user and a task executed by the user (i.e., one example of the target request information), the Action Learner is configured to infer reasons for each step performed by the user, thereby generating action knowledge (i.e., Action Knowledge) corresponding to the task, and storing the action knowledge in a knowledge base (i.e., one example of the target knowledge base) for invocation by a LAM. Here, a structure of the knowledge base is a knowledge graph (Knowledge Graph, KG). The knowledge base includes a one-to-many correspondence between Sub-Task Knowledge and Action Knowledge, thereby forming a graph structure, that is, a root node corresponding to a plurality of child nodes.

In addition, a Sub-Task Extractor processes Action Knowledge of a specific task. For example, the Action Knowledge of the specific task is input into the Sub-Task Extractor to extract Sub-Task Knowledge. The Sub-Task Knowledge has a broader scope than the Action Knowledge, and may be shared by a plurality of tasks similar to the specific task. The Sub-Task Knowledge may serve as a root node corresponding to a plurality of Action Knowledge nodes, may be shared by a plurality of similar tasks, and may be stored as part of a multi-level structure of KG.

Knowledge generated by these two types of learning processes is respectively stored in the knowledge base to add task flows that have not been executed before, or to improve task flows that have been executed previously. In this manner, interface updates may be handled, and when executing the same task in the future, user preferences may be preserved.

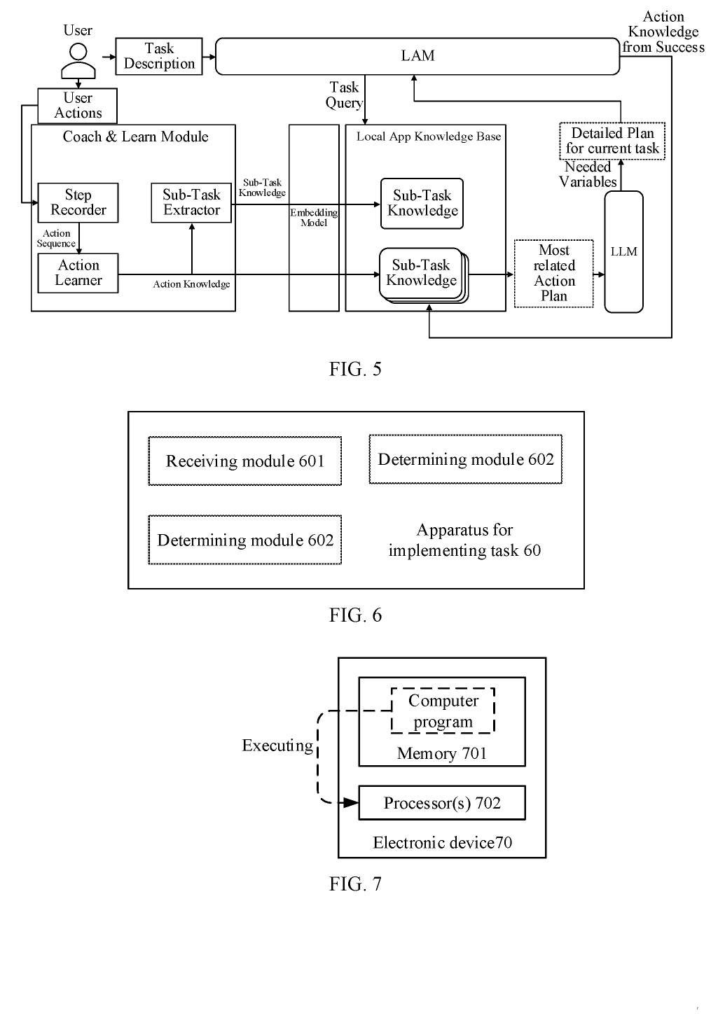

FIG. 5 illustrates a fourth schematic flowchart of a method for implementing a task in accordance with some embodiments of the present disclosure. As shown in FIG. 5, a user (i.e., User) executes a second task. A learning module obtains execution steps of the user (i.e., User Actions) and inputs the execution steps into a script recorder (i.e., Step Recorder) to obtain an action sequence (i.e., Action Sequence). The action sequence is input into an action learning module (i.e., Action Learner) to obtain Action Knowledge. The Action Knowledge is input into a Sub-Task Extractor to extract Sub-Task Knowledge. The Sub-Task Knowledge is stored in Sub-Task Knowledge of a knowledge base of a local application, and the Action Knowledge is stored in Sub-Task Knowledge of a knowledge base (i.e., Local App Knowledge Base) of the local application. A Task Description input by the user (i.e., one example of target request information of the first task) is received, and a task query instruction is generated based on the Task Description to query, from the knowledge base, a most related action plan (i.e., Most Related Action Plan) corresponding to the first task. The action plan is input into an LLM to obtain a detailed plan for a current task (i.e., Detailed Plan for current task), thereby obtaining a target control instruction. The target control instruction is executed to implement the first task. When the first task is successfully implemented (i.e., Action Knowledge from Success), knowledge corresponding to the first task is stored in the knowledge base. Here, Needed Variables include the target request information; a Coach & Learn Module is a modular learning system that integrates guidance and learning functions into an independent unit, and assists in skill improvement and knowledge acquisition through preset learning paths and feedback mechanisms; and an Embedding Model is a technique for mapping discrete high-dimensional data into low-dimensional continuous vector representations.

It should be noted that, although various steps of the method of the present disclosure are described in a particular order with reference to the accompanying drawings, this does not require or imply that the steps must be performed in that particular order, or that all illustrated steps must be performed to achieve desired results. Additional or alternative steps may be performed, certain steps may be omitted, multiple steps may be combined into a single step, and/or a single step may be divided into a plurality of steps. Further, steps from different embodiments may be combined to form new technical solutions.

Based on the foregoing embodiments, embodiments of the present disclosure further provide an apparatus. The apparatus includes a plurality of modules, and each module includes a plurality of units. The modules and the units may be implemented by a processor, or alternatively, may be implemented by specific logic circuits. During implementation, the processor may be an artificial intelligence (AI) acceleration engine (e.g., a neural processing unit (NPU)), a graphics processing unit (GPU), a central processing unit (CPU), a microprocessor unit (MPU), a digital signal processor (DSP), a field programmable gate array (FPGA), or the like.

FIG. 6 illustrates a schematic structural diagram of an apparatus for implementing a task according to some embodiments of the present disclosure. As shown in FIG. 6, apparatus 60 includes a receiving module 601, a determining module 602, and an obtaining module 603.

The receiving module 601 is configured to receive target request information, where the target request information is used to describe a first task to be implemented.

The determining module 602 is configured to determine target reference information from a target knowledge base based on the target request information, where the target reference information is used to describe execution steps of a second task, and the second task and the first task satisfy a similarity relationship.

The obtaining module 603 is configured to determine target input information based on the target request information and the target reference information and input the target input information into a target model to obtain a target control instruction generated by the target model, where the target control instruction is used to control a target device to execute the first task.

In some embodiments of the present disclosure, the target reference information includes at least one of: execution intent information corresponding to at least one step in the execution steps of the second task; or a control instruction corresponding to at least one step in the execution steps of the second task.

In some embodiments of the present disclosure, the obtaining module 603 is configured to: determine the target input information based on the target request information, the target reference information, screenshot information of a target interface, and preset prompt information, where the target input information is used to guide the target model to perform inference, and the target interface is used for executing the target control instruction; and, input the target input information into the target model.

In some embodiments of the present disclosure, the target control instruction is a first control instruction, the target interface is a first interface, and the target input information is first input information. The apparatus 60 further includes a control module, where the control module is configured to control the target device to execute the first control instruction such that the first interface is changed to a second interface. The determining module 602 is further configured to determine second prompt information based on the target input information, the target reference information, screenshot information of the second interface, and preset prompt information. The obtaining module 603 is further configured to input the second prompt information into the target model to obtain a second control instruction generated by the target model, where the first control instruction and the second control instruction cooperate to control the target device to execute the first task.

In some embodiments of the present disclosure, the obtaining module 603 is configured to: replace first object information in the target reference information with second object information to obtain replacement reference information, where the second object information is determined from the target reference information; and, determine the target input information based on the target request information and the replacement reference information.

In some embodiments of the present disclosure, the determining module 602 is configured to: match a target root node from the target knowledge base based on the target request information; and, determine the target reference information from at least one piece of candidate reference information associated with the target root node, where each piece of candidate reference information corresponds to a candidate reference task.

In some embodiments of the present disclosure, the apparatus 60 further includes a storage module. The obtaining module 603 is configured to obtain operation step information of an operator, where the operation step information corresponds to execution steps of the second task. The determining module 602 is configured to determine candidate reference information based on the operation step information. The storage module is configured to store the candidate reference information in the target knowledge base.

In some embodiments of the present disclosure, the determining module 602 is configured to: obtain operation description information input by an operator corresponding to operation step information; and determine the candidate reference information based on the operation step information and the operation description information.

In some embodiments of the present disclosure, the determining module 602 is configured to: identify first execution intent information corresponding to a first step in the operation step information; identify second execution intent information corresponding to a second step in the operation step information based on the first execution intent information; and, determine the candidate reference information based on the first execution intent information and the second execution intent information.

The descriptions of the above apparatus embodiments are similar to those of the foregoing method embodiments, and have similar beneficial effects as the method embodiments. For technical details not disclosed in the apparatus embodiments of the present disclosure, reference may be made to the descriptions of the method embodiments.

It should be noted that the division of modules in the embodiments of the present disclosure is illustrative and is merely a logical functional division. In actual implementation, other division manners may be used. In addition, the functional units in the embodiments of the present disclosure may be integrated into one processing unit, or may exist as independent physical entities, or two or more units may be integrated into one unit. The above integrated units may be implemented in the form of hardware, software functional units, or a combination of software and hardware.

It should be further noted that, when the above-described methods are implemented in the form of software functional modules and are sold or used as independent products, they may be stored in a computer-readable storage medium. Based on such understanding, the technical solutions of the present disclosure, or the part contributing to the existing technology, may be embodied in the form of a software product. The computer software product is stored in a storage medium and includes a plurality of instructions for causing an electronic device to perform all or part of the steps of the methods described in the embodiments of the present disclosure. The storage medium may include, but is not limited to, a USB flash drive, a removable hard disk, a read-only memory (ROM), a magnetic disk, an optical disk, or other media capable of storing program code. Accordingly, the embodiments of the present disclosure are not limited to any specific combination of hardware and software.

Embodiments of the present disclosure further provide an electronic device. FIG. 7 illustrates a schematic structural diagram of an electronic device according to some embodiments of the present disclosure. As shown in FIG. 7, the electronic device 70 includes a memory 701 and processor(s) 702. The memory 701 stores a computer program executable on the processor 702, and the processor 702 implements the steps of the method described in the above embodiments when executing the computer program.

It should be noted that the memory 701 is configured to store instructions and applications executable by the processor 702, and may further cache data to be processed or already processed by the processor 702 and various modules in the electronic device 70. The memory 701 may be implemented by flash memory (Flash) or random access memory (RAM).

Embodiments of the present disclosure further provide a computer-readable storage medium, on which a computer program is stored. When the computer program is executed by a processor, the steps of the method described in the above embodiments are implemented.

Embodiments of the present disclosure further provide a computer program product including instructions. When the instructions are executed on a processor, the processor is caused to perform the steps of the method described in the above method embodiments.

It should be noted that the descriptions of the above storage medium and device embodiments are similar to those of the method embodiments and have similar beneficial effects as the method embodiments. For technical details not disclosed in the storage medium and device embodiments of the present disclosure, reference may be made to the descriptions of the method embodiments.

It should be understood that the terms “one embodiment,” “an embodiment,” “some embodiments,” “in a possible implementation,” or “example” described throughout the specification indicate that specific features, structures, or characteristics described in connection with the embodiments are included in at least one embodiment of the present disclosure. Thus, appearances of such terms throughout the specification do not necessarily refer to the same embodiment. Furthermore, such specific features, structures, or characteristics may be combined in any suitable manner in one or more embodiments. It should be understood that, in the various embodiments of the present disclosure, the sequence numbers of the processes do not imply an order of execution. The execution order of the processes should be determined based on their functions and internal logic, and should not constitute any limitation to the implementation of the embodiments of the present disclosure. The sequence numbers are merely used for description and do not indicate superiority or inferiority of the embodiments. The foregoing descriptions of the embodiments emphasize differences among the embodiments, and similarities among them may be referred to each other. For brevity, details are not repeated herein.

The term “and/or” used herein describes an association relationship between associated objects and indicates that three relationships may exist. For example, A and/or B may indicate: A alone exists, both A and B exist, or B alone exists.

It should be noted that the terms “include,” “including,” or any other variations thereof are intended to cover non-exclusive inclusion, such that a process, method, article, or apparatus that includes a series of elements not only includes those elements but also includes other elements not expressly listed, or further includes elements inherent to such process, method, article, or apparatus. Unless further limited, an element defined by the phrase “including a …” does not exclude the presence of other identical elements in the process, method, article, or apparatus that includes the element. In the embodiments provided in the present disclosure, it should be understood that the disclosed apparatus and device may be implemented in other manners. The described embodiments are merely illustrative. Features disclosed in different embodiments may be combined in any suitable manner without conflict to form new embodiments.

The foregoing descriptions are merely embodiments of the present disclosure and are not intended to limit the scope of the present disclosure. Any modifications or substitutions that can be readily conceived by those skilled in the art within the technical scope disclosed by the present disclosure shall fall within the scope of the present disclosure. Therefore, the scope of the present disclosure shall be defined by the appended claims.

What is claimed is:

1. A method for implementing a task, the method comprising:
receiving target request information that describes a first task to be implemented;
determining, based on the target request information, target reference information from a target knowledge base, wherein the target reference information describes execution steps of a second task, and the second task and the first task satisfy a similarity relationship;
determining target input information based on the target request information and the target reference information; and
inputting the target input information into a target model to obtain a target control instruction generated by the target model, wherein the target control instruction controls a target device to execute the first task.

2. The method according to claim 1, wherein the target reference information comprises at least one of:
execution intent information corresponding to at least one step in the execution steps of the second task; or
a control instruction corresponding to at least one step in the execution steps of the second task.

3. The method according to claim 1, wherein determining the target input information based on the target request information and the target reference information comprises:
determining the target input information based on the target request information, the target reference information, screenshot information of a target interface, and preset prompt information; and
inputting the target input information into the target model,
wherein the target input information guides the target model to perform inference, and the target interface is configured for executing the target control instruction.

4. The method according to claim 3, further comprising:
controlling the target device to execute the target control instruction, wherein the target interface is changed into a second interface in response to execution of the target control instruction;
determining second prompt information based on the target input information, the target reference information, screenshot information of the second interface, and preset prompt information; and
inputting the second prompt information into the target model to obtain a second control instruction generated by the target model, wherein the target control instruction and the second control instruction cooperate to control the target device to execute the first task.

5. The method according to claim 1, wherein determining the target input information based on the target request information and the target reference information comprises:
replacing first object information in the target reference information with second object information to obtain replacement reference information, wherein the second object information is determined from the target reference information; and
determining the target input information based on the target request information and the replacement reference information.

6. The method according to claim 1, wherein determining the target reference information from the target knowledge base based on the target request information comprises:
matching a target root node from the target knowledge base based on the target request information; and
determining the target reference information from at least one piece of candidate reference information associated with the target root node, wherein each piece of candidate reference information corresponds to a candidate reference task.

7. The method according to claim 1, the method further comprising:
obtaining operation step information of an operator, the operation step information corresponding to operation steps for executing the second task;
determining candidate reference information based on the operation step information; and
storing the candidate reference information in the target knowledge base.

8. The method according to claim 7, wherein determining the candidate reference information based on the operation step information comprises:
obtaining operation description information input by the operator corresponding to the operation step information; and
determining the candidate reference information based on the operation step information and the operation description information.

9. The method according to claim 7, wherein determining the candidate reference information based on the operation step information comprises:
identifying first execution intent information corresponding to a first step in the operation step information;
identifying second execution intent information corresponding to a second step in the operation step information based on the first execution intent information; and
determining the candidate reference information based on the first execution intent information and the second execution intent information.

10. An electronic device comprising:
one or more processors; and
a memory storing instructions that, when being executed, cause the one or more processors to:
receive target request information that describes a first task to be implemented;
determine target reference information from a target knowledge base based on the target request information, wherein the target reference information describes execution steps of a second task, and the second task and the first task satisfy a similarity relationship;
determine target input information based on the target request information and the target reference information; and
input the target input information into a target model to obtain a target control instruction generated by the target model, wherein the target control instruction controls a target device to execute the first task.

11. The device according to claim 10, wherein the target reference information comprises at least one of:
execution intent information corresponding to at least one step in the execution steps of the second task; or
a control instruction corresponding to at least one step in the execution steps of the second task.

12. The device according to claim 10, wherein the one or more processors are further configured to:
determine the target input information based on the target request information, the target reference information, screenshot information of a target interface, and preset prompt information; and
input the target input information into the target model,
wherein the target input information guides the target model to perform inference.

13. The device according to claim 12, wherein the one or more processors are further configured to:
control the target device to execute the target control instruction, wherein the target interface is changed into a second interface in response to execution of the target control instruction;
determine second prompt information based on the target input information, the target reference information, screenshot information of the second interface, and preset prompt information; and
input the second prompt information into the target model to obtain a second control instruction, wherein the target control instruction and the second control instruction cooperate to control the target device to execute the first task.

14. The device according to claim 10, wherein the one or more processors are further configured to:
replace first object information in the target reference information with second object information to obtain replacement reference information; and
determine the target input information based on the target request information and the replacement reference information.

15. The device according to claim 10, wherein the one or more processors are further configured to:
match a target root node from the target knowledge base based on the target request information; and
determine the target reference information from at least one piece of candidate reference information associated with the target root node.

16. A non-transitory computer-readable storage medium storing instructions that, when being executed, cause at least one processor to:
receive target request information that describes a first task to be implemented;
determine target reference information from a target knowledge base based on the target request information, wherein the target reference information describes execution steps of a second task, and the second task and the first task satisfy a similarity relationship;
determine target input information based on the target request information and the target reference information; and
input the target input information into a target model to obtain a target control instruction generated by the target model, wherein the target control instruction controls a target device to execute the first task.

17. The storage medium according to claim 16, wherein the target reference information comprises at least one of:
execution intent information corresponding to at least one step in the execution steps of the second task; or
a control instruction corresponding to at least one step in the execution steps of the second task.

18. The storage medium according to claim 16, wherein the at least one processor is further configured to:
determining the target input information based on the target request information, the target reference information, screenshot information of a target interface, and preset prompt information; and
inputting the target input information into the target model,
wherein the target input information guides the target model to perform inference.

19. The storage medium according to claim 16, wherein the at least one processor is further configured to:
control the target device to execute the target control instruction such that a target interface is changed into a second interface;
determine second prompt information based on the target input information, the target reference information, and screenshot information of the second interface; and
input the second prompt information into the target model to obtain a second control instruction, wherein the target control instruction and the second control instruction cooperate to control the target device to execute the first task.

20. The storage medium according to claim 16, wherein the at least one processor is further configured to:
match a target root node from the target knowledge base based on the target request information; and
determine the target reference information from at least one piece of candidate reference information associated with the target root node.
